(19) United States
(12) Patent Application Publication
(10) Pub. No.: US 2026/0319323 A1
(43) Pub. Date: Oct. 15, 2026

(54) ELECTRO-OPTIC MODULATORS AND METHODS OF OPERATION

(71) Applicant: BLACKLINK TECHNOLOGIES, S.L., Viladecans (ES)

(72) Inventor: Bernat TERRÉS GÜERRI, Barcelona (ES)

(21) Appl. No.: 19/476,289

(22) PCT Filed: Apr. 18, 2024
(86) PCT No.: PCT/EP2024/060641

§ 371 Date: Oct. 17, 2025

(30) Foreign Application Priority Data
Apr. 20, 2023 (EP) 23382367.3

(51) Int. Cl. G02F 1/225; G02F 1/21

(52) U.S. Cl. CPC G02F 1/225; G02F 1/212

(57) ABSTRACT

The present disclosure relates to electro-optic modulators and methods of operating the electro-optic modulators. An electro-optic modulator comprises a substrate, an optical waveguide arranged with the substrate, and a first graphene layer such that input light is absorbed by the electro-optic modulator during operation. The electro-optic modulator is configured to operate at wavelengths between 8 micrometers and 15 micrometers.

The present application claims the benefit of EP 23382367.3 filed on Apr. 20, 2023.

### FIELD

The present disclosure relates to electro-optic modulators, and in particular to graphene based electro-optic modulators comprising a waveguide. The present disclosure further relates to methods of operating electro-optic modulators comprising waveguides.

### BACKGROUND

A modulator is a device which can be used for manipulating a property of light, for example a property of a laser beam, which goes through the modulator. Depending on which property of light is controlled or modulated, modulators may for example be referred to as amplitude modulators, phase modulators, polarization modulators, frequency modulators or other.

An electro-optic modulator is a device in which light is manipulated by using an electric signal. The modulation may e.g. be imposed on the phase, amplitude, or polarization of the beam. This electric signal is usually applied to the electro-optic modulator by a driving circuit. This electric signal may be a current, but it is usually a voltage, usually referred to as driving voltage, drive voltage or applied voltage. The terms driving voltage, drive voltage and applied voltage are used interchangeably throughout this disclosure.

FIG. 1 schematically illustrates an example of an absorption curve of a graphene electro-optic modulator, in normalized units, as a function of the drive voltage V_{D}, in volts. The normalized absorption refers to the light absorbed by the modulator at a specific drive voltage divided by the maximum absorption of the modulator. The term normalized absorption, as defined here, is used throughout this disclosure. The curve is shown for an operating light wavelength (λ) of 1.55 micrometers. The wavelengths λ=1550 nm and λ=850 nm are usually used in Tele-and Data-communications (TeleCom and DataCom, respectively) but the same trace behavior is valid for other wavelengths, including all wavelengths supported by the graphene. As may be seen in the example of this figure, not all drive voltages can modulate the light going through the electro-optic modulator. The range of voltages which can do so is referred to as Range of operation.

The offset voltage, also known as DC offset, represents the minimum voltage value required to reach the Range of operation, and thereby represents the minimum voltage value required to modulate the light that forms the input of the electro-optic modulator. A typical range of offset voltages for state-of-the art electro-optic modulators may be between 1 V and 20 V, although the lower values of offset voltage (DC offsets close to 1V) may be achieved by electro-optic modulators that include a current amplifier, a voltage amplifier or a transimpedance amplifier, either in the modulator itself or in the driving circuit.

Modulators with a high DC offset operate with high drive voltages and have therefore further disadvantages. A high offset voltage is associated with a high-power consumption. This is detrimental for all applications in general, but particularly for servers or battery-powered applications. A high-power consumption is generally associated with significant heat generation, which decreases the performance and the stability of the electro-optic modulator, i.e. it lowers the static and the dynamic modulation efficiencies. This is particularly relevant for graphene-based modulators, as shown by FIG. 16, where the static modulation efficiency decreases as a function of temperature. A higher temperature may as well narrow the temperature stability range, i.e. the range of temperatures in which an electro-optic modulator operates without significant performance degradation.

Reducing the effective DC offset voltage by means of a current amplifier, a voltage amplifier or a transimpedance amplifier, is complex and expensive. Those amplifiers, apart from adding cost to the driving circuit, are limited in speed and may therefore limit the speed of the modulator. This is especially relevant for high-speed modulators, such as the graphene based electro-optic modulators, for which the speed of the modulator is far beyond the speed capabilities of state-of-the-art amplifiers.

An amplifier such as a current amplifier, a voltage amplifier or a transimpedance amplifier may introduce noise, offsets, distortions and timing jitter, understood as the variation of a signal from its ideal position in time. Noise, offsets, distortions, and timing jitter cause bit errors, which become even more detrimental in high-speed data transmissions.

Electro-optic modulators with a high offset voltage require high voltage signals to operate, and thus may be subjected to more stress and may become less reliable. That is particularly important for graphene-based modulators, which are more sensitive and prone to break.

Graphene electro-optic modulators are characterized by having high DC offset voltages, typically in the range of several tens of volts. On the other hand, graphene based electro-optic modulators support high modulation speeds, potentially up to hundreds of GHz, thereby accentuating the disadvantages mentioned previously.

The present disclosure provides electro-optic modulators, in particular graphene electro-optic modulators, which mitigate or eliminate one or more of the above disadvantages, and in particular which do so without compromising the speed of the electro-optic modulators, and even improving the static and dynamic efficiencies.

### SUMMARY

In an aspect of the present disclosure, an electro-optic modulator is provided. The electro-optic modulator comprises a substrate, an optical waveguide arranged with the substrate, a first graphene layer and a second graphene layer arranged such that input light is absorbed by the electro-optic modulator during operation, the first and second graphene layers overlapping each other and separated from each other by one or more dielectric layers. The electro-optic modulator is configured to operate at wavelengths between 8 micrometers and 15 micrometers.

According to this aspect, an electro-optic modulator based on graphene is configured to operate in the long wavelength infrared range (LWIR), i.e. between 8 and 15 micrometers. Operation in this range can greatly reduce the offset voltage of the modulator. The offset voltage may for example be less than 1 V, 0.5 V, 0.2 V or 0.1 V, e.g. about 0 V. I.e., having to overcome an offset voltage for starting the modulation may be avoided by operating the graphene-based electro-optic modulator in this wavelength range. Or at least, the offset voltage may be very small.

Disadvantages linked to a high offset voltage can therefore be avoided without compromising the modulation speed, and the static and dynamic efficiency of the electro-optic modulator may be increased.

The LWIR range may be understood as a wavelength range between 8 micrometers and 15 micrometers. Below the LWIR range there is the mid wavelength infrared range (MWIR), which may be understood as a wavelength range between 3 micrometers and 8 micrometers. Still below the MWIR there is the near wavelength infrared range (NWIR) and the short wavelength infrared (SWIR) range. Traditional electro-optic modulators operate in these two last ranges (NWIR and SWIR), e.g. at 1550 nm and 850 nm, respectively.

In some examples, the bottom (i.e. the first) and top (i.e. the second) graphene layers may overlap with each other along at least a portion of the optical waveguide's width.

In some examples, the bottom and top graphene layers may overlap with each other along exactly the width of the optical waveguide.

In some examples, the bottom and top graphene layers may overlap with each other the entire waveguide's width and beyond.

In some examples, the first (bottom) and second (top) graphene layers may be arranged above the waveguide. In other examples, the first and second graphene layers may be arranged below the waveguide. In other examples, the first and second graphene layers may be arranged within the waveguide.

In some examples, the optical waveguide may comprise a group IV semiconductor such as carbon (C), silicon (Si), germanium (Ge), tin (Sn) or lead (Pb). For example, the waveguide may comprise Ge, and in particular SiGe. The waveguide may in particular be a Germanium waveguide or a Germanium-on-Silicon waveguide. Ge and SiGe material may be particularly beneficial for the waveguide as the losses of the waveguide may be particularly low, e.g. below 4 dB/cm for a Ge waveguide and below 5 dB/cm for a SiGe waveguide, for operating wavelengths between 8 and 15 micrometers. In general, the transparency of the group IV semiconductors may be particularly high for operating wavelengths between 8 and 15 micrometers.

In these or other examples, the waveguide may comprise SiC, GeSn, GeC, SiGeSn, Si₃N₄ (e.g. Si₃N₄ polymers), sapphire and/or chalcogenides (e.g. chalcogenide glass material). The waveguide may e.g. be a Silicon-on-Nitride (SON) waveguide, a Silicon waveguide, a Silicon-on-Insulator (SOI) waveguide, a Silicon-on-Nitride-on-Insulator (SONOI) waveguide, a Silicon-on-Sapphire (SOS) waveguide, a Chalcogenide-on-Silicon waveguide, a suspended Silicon waveguide, a suspended Germanium waveguide, an Arsenic Selenide waveguide, an Arsenic Sulfide waveguide, a hollow (air) waveguide, or a polymer-based waveguide. These waveguides may also be suitable for operating in the LWIR range.

The losses of the waveguide may also be particularly low for operating wavelengths between 8 and 15 micrometers for at least some of the previously mentioned compounds. For example, light confinement may be tight and a SiC waveguide, a SiGeSn waveguide, a GeC waveguide, a GeSn waveguides, may respectively have losses below 7 dB/cm, 8 dB/cm, 9 dB/cm and 10 dB/cm for operating wavelengths between 8 and 15 micrometers.

In some examples, the waveguide may comprise a III-V semiconductor as the transparency of these materials may also be particularly high for operating wavelengths between 8 and 15 micrometers.

In a further aspect of the disclosure, a method of operating an electro-optic modulator as described throughout this disclosure is provided. The method comprises sending a light input having a wavelength, e.g. of a wavelength, between 8 micrometers and 15 micrometers to the optical waveguide. The method further comprises modulating the light input.

As the waveguide is particularly configured to operate in the wavelength range between 8 micrometers and 15 micrometers, the graphene-based electro-optic modulator may be operated with a small drive voltage as the offset voltage that needs to be overcome may be very small. The modulation may be performed with lower power consumption and with high reliability. The modulation may also be performed with increased static and dynamic efficiencies, and without compromising the speed of the modulator.

In some examples, the offset voltage, i.e. the DC component of the driving voltage, may be lower than 1 V, in particular lower than 0.5 V and more in particular lower than 0.2 V. In some of these examples, an offset voltage may be lower than 0.1 V, e.g. about or of 0 V.

### BRIEF DESCRIPTION OF THE DRAWINGS

FIG. 1 schematically illustrates an example of a normalized absorption curve of an electro-optic modulator as a function of drive voltage for a wavelength of 1.55 micrometers.

FIG. 2 schematically illustrates an example of a graphene-based electro-optic modulator configured to operate in the 1.55 micrometers wavelength.

FIG. 3 schematically illustrates a cross-section of a second example of a graphene-based electro-optic modulator configured to operate in the 1.55 micrometers wavelength, similar to the electro-optic modulator of FIG. 2 but with a portion of the cladding layer on top of, i.e. covering, the waveguide; and the bottom (Gb) and top (Gu) top graphene layers overlapping with each other only for the width of the entire waveguide (C)'s.

FIG. 4 schematically illustrates an example of a graphene-based electro-optic modulator configured to operate at 8 micrometers wavelength.

FIG. 5 schematically illustrates a cross-section of the electro-optic modulator of FIG. 4, but with a portion of the cladding layer on top of, i.e. covering, the waveguide.

FIG. 6 schematically illustrates an example of the evolution of the normalized absorption of a graphene electro-optic modulator such as the ones of FIGS. 2-5 as a function of the wavelength of the input light and the drive voltage.

FIG. 7 schematically illustrates the evolution of normalized absorption as a function of drive voltage for four cuts taken at the four operating wavelengths indicated with the vertical lines in FIG. 6: 1.55 micrometers, 3 micrometers, 8 micrometers and 15 micrometers. The white dashed line indicates the Operating voltage of the electro-optic modulator.

FIG. 8 schematically illustrates an enlarged view of the region up to a drive voltage of 2 V of FIG. 7.

FIG. 9 shows a graph with curves of transmission as a function of applied (drive) voltage for different thicknesses of the dielectric layer D2 of the electro-optic modulator of FIG. 2 operating with a 1.55 micrometers light.

FIG. 10 shows a graph with lines of bandwidth as a function of thickness of the dielectric layer D2 of the electro-optic modulator of FIG. 2 operating with a 1.55 micrometers light for different graphene-to-metal contact resistivities.

FIG. 11 shows a graph with curves of bandwidth as a function of permittivity of the dielectric layer D2 of the electro-optic modulator of FIG. 2 operating with a 1.55 micrometers light. The curves are shown for different graphene-to-metal contact resistivities.

FIG. 12 shows a graph with curves of transmission as a function of applied voltage for different permittivities of the dielectric layer D2 of the electro-optic modulator of FIG. 2 operating with a 1.5 micrometers light.

FIG. 13 shows a graph with curves of transmission as a function of applied voltage for different thicknesses of the dielectric layer D2 of the electro-optic modulator of FIG. 4 operating with a 8 micrometers light.

FIG. 14 shows a graph with curves of transmission as a function of applied voltage for different permittivities of the dielectric layer D2 of the electro-optic modulator of FIG. 4 operating with a 8 micrometers light.

FIG. 15 shows a graph with curves of transmission as a function of applied voltage for different lengths of the electro-optic modulator of FIG. 4 operating with a 8 micrometers light.

FIG. 16 shows a graph with curves of transmission as a function of applied voltage for the electro-optic modulator of FIG. 4 operating with a 8 micrometers light at different temperatures of operation.

FIG. 17 schematically illustrates a method of operating an electro-optic modulator.

### DETAILED DESCRIPTION OF EXAMPLES

Reference now will be made in detail to embodiments of the present disclosure, one or more examples of which are illustrated in the drawings. Each example is provided by way of explanation only, not as a limitation. In fact, it will be apparent to those skilled in the art that various modifications and variations can be made in the present disclosure. For instance, features illustrated or described as part of one embodiment can be used with another embodiment to yield a still further embodiment. Thus, it is intended that the present disclosure covers such modifications and variations as come within the scope of the appended claims and their equivalents.

According to an aspect of the disclosure, an electro-optic modulator is provided. The electro-optic modulator comprises a substrate, an optical waveguide arranged with the substrate, a first graphene layer and a second graphene layer arranged such that input light is absorbed by the electro-optic modulator during operation, the first and second graphene layers overlapping each other and separated from each other by one or more dielectric layers. The electro-optic modulator is configured to operate at wavelengths between 8 micrometers and 15 micrometers.

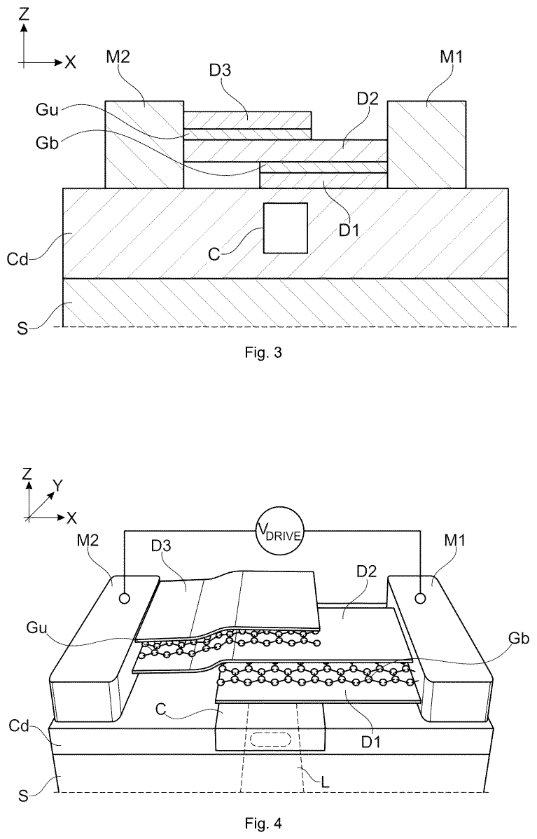

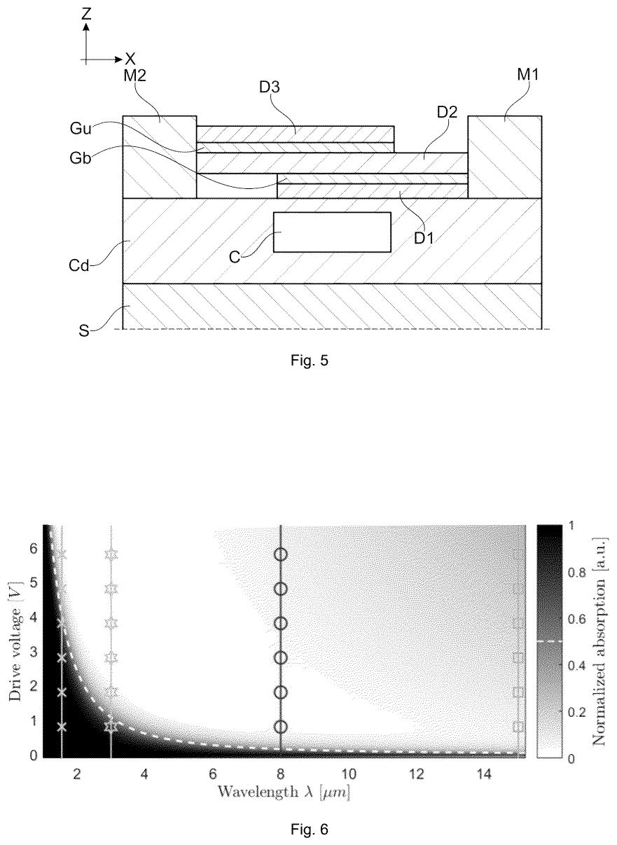

Schematic examples of an electro-optic modulator are shown in FIGS. 2 to 5. The electro-optic modulators of FIGS. 2 and 3 are configured to operate in the NWIR range, e.g. at 1.55 micrometers. The electro-optic modulators of FIGS. 4 and 5 are configured to operate in the LWIR range, e.g. at 8 micrometers. As illustrated in the figures, the dimensions of different components of the electro-optic modulators, e.g. of the optical waveguide and the graphene and dielectric layers, are different in both examples such that each electro-optic modulator may operate in its corresponding wavelength range.

The electro-optic modulator of these examples comprises a substrate. The substrate comprises a bottom portion or layer S, typically a semiconductor, and a top portion or layer Cd, typically an oxide material. In the examples of FIGS. 2-5, the top layer Cd of the substrate, also called cladding, is on top of the bottom layer S of the substrate.

The bottom substrate S may be made of a group IV semiconductor in some examples. In other examples, it may be made of a III-V semiconductor, a II-VI semiconductor, a chalcogenide material, a polymer material, a nitride material, an oxide material, a crystal material, an organic or hybrid material, a metal, a glass, air, vacuum or other material. For example, the bottom substrate S may be made of Si (silicon). In other examples, it may be made of silicon dioxide or glass or other material. The bottom portion of the substrate S may act solely as a support for the layers on top of it and may therefore not bei strictly necessary for the electro-optic modulator to operate. The bottom substrate S may be eliminated in some cases, and leave the top portion Cd of the substrate acting as a support for the rest of the layers on top. In some other cases the bottom substrate S may be part of the optical waveguide.

The top portion of the substrate Cd may comprise, e.g. may be made of, an oxide material, a nitride material, a polymer material, a fluoride glass, a chalcogenide glass material, a chalcogenide material, a semiconductor material, air or vacuum. For example, in the case of oxides, the layer material Cd may comprise, e.g. be made of, SiO₂ (Silicon Dioxide), or aluminum oxide (Al₂O₃), or phosphorus pentoxide (P₂O₅), or boron oxide (B₂O₃), or magnesium oxide (MgO), or calcium oxide (CaO), or tantalum (V) oxide (Ta₂O₅), or HfO₂ (hafnium oxide), or titanium dioxide (TiO₂), or zirconium dioxide (ZrO₂), to mention a few.

In other examples, for example for the case of nitrides, the layer material Cd may comprise, e.g. be made of, Silicon Nitride (SiₓNₓ), or Aluminum Nitride (AlN), or Gallium Nitride (GaN), or Boron Nitride (BN), or Titanium Nitride (TiN) or Indium Nitride (InN), or Tantalum Nitride (TaN), or Tungsten Nitride (WN), to mention a few.

In examples for the case of polymers, the layer material Cd may comprise, e.g. be made of, Polymethyl Methacrylate (PMMA), or Polytetrafluoroethylene (PTFE), or Perfluorinated Polymers, or Polystyrene (PS), or Polyethylene (PE), or Polypropylene (PP) or Polyvinyl Chloride (PVC), or Polycarbonate (PC), or SU-8, to mention a few.

For example, for the case of Fluoride glasses, the layer material Cd may comprise, e.g. be made of, Indium Fluoride (InF₃) Glasses, or Gallium Fluoride (GaF₃) Glasses, or Aluminum Fluoride (AlF₃) Glasses, or ZBLAN (Zr—Ba—La—Al—Na fluorides) Glasses, to mention a few.

For example, for the case of Chalcogenides, the layer material Cd may comprise, e.g. be made of, Arsenic Trisulfide (As₂S₃), or Arsenic Selenide (As₂Se₃), or Germanium-Antimony-Sulfur (Ge—Sb—S) Systems, or Germanium-Antimony-Selenium (Ge—Sb—Se) Systems, or Tellurium-based Chalcogenides, or Indium-based Chalcogenides, to mention a few.

For example, for the case of Semiconductors, the layer material Cd may comprise, e.g. be made of, Silicon Germanium (SiGe), or Indium Gallium Arsenide Phosphide (InGaAsP), or Indium Aluminium Arsenide (InAlAs), or Indium Gallium Arsenide (InGaAs), to mention a few.

The layer material Cd, also called cladding, may optionally cover the waveguide C (shown in FIGS. 3 and 5), separating the waveguide C from the Gb layer, and/or the dielectric layer D1, and/or the dielectric layer D2. The portion of the cladding layer separating the waveguide C from the rest of the upper layers, if present, may e.g. be from 1 to 10 nm thick.

The electro-optic modulator further comprises an optical waveguide C arranged with the substrate, for example with the top portion of the substrate Cd. The optical waveguide C may be made of different materials. The waveguide C may comprise, e.g. may be made of a group IV semiconductor, a III-V semiconductor, a II-VI semiconductor, a chalcogenide glass material, a chalcogenide material, a polymer material, an oxide material, a nitride material, a crystal material, an organic or hybrid material, a two-dimensional (2D) material, a nanostructured material, a suspended material, a metal, air (hollow) or vacuum.

For example, for the case of group IV semiconductors, the waveguide C may comprise, e.g. be made of, Carbon (C), Silicon (Si), Germanium (Ge), Tin (Sn), or Lead (Pb), either used individually or in a combination thereof.

For example, for the case of III-V compound semiconductors, the waveguide C may comprise, e.g. be made of, Gallium Arsenide (GaAs) in some examples, or Indium Phosphide (InP), or indium Gallium Arsenide (InGaAs), or Indium Gallium Arsenide Phosphide (InGaAsP), to mention a few.

For example, for the case of II-VI compound semiconductors, the waveguide C may comprise, e.g. be made of, Zinc Selenide (ZnSe) in some examples, or Zinc Sulfide (ZnS), or Cadmium Telluride (CdTe), to mention a few.

For example, for the case of chalcogenides, the waveguide C may comprise, e.g. be made of, Arsenic Trisulfide (AS₂S₃) in some examples, or Germanium-Antimony-Sulfur (Ge—Sb—S) systems, to mention a few.

For example, for the case of 2D materials, the waveguide C may comprise, e.g. be made of, a Transition Metal Dichalcogenide in some examples (e.g. Molybdenum Disulfide (MoS2) or Tungsten Disulfide (WS2), to mention a few), or Graphene, to mention a few.

For example, for the case of oxides, the waveguide C may comprise, e.g. be made of, Silica (SiO₂) in some examples, or doped Silica, or Sapphire, to mention a few.

For example, for the case of polymers, the waveguide C may comprise, e.g. be made of, Polymethyl Methacrylate (PMMA) in some examples, or Polystyrene, or Polyimides, or Fluorinated Polymers, to mention a few.

For example, for the case of nitrides, the waveguide C may comprise, e.g. be made of, Silicon Nitride (Si₃N₄) in some examples, or Gallium Nitride (GaN), to mention a few.

For example, for the case of crystals, the waveguide C may comprise, e.g. be made of, Lithium Niobate (LiNbO₃) in some examples, or Potassium Titanyl Phosphate (KTP), or Beta Barium Borate (BBO), to mention a few.

For example, for the case of organic or hybrid materials, the waveguide C may comprise, e.g. be made of, an organic material with nonlinear optical properties in some examples, or an Organic-Inorganic hybrid material, to mention a few.

For example, for the case of nanostructured materials, the waveguide C may comprise, e.g. be made of, a photonic crystal in some examples

The optical waveguide C may comprise Ge. Such a waveguide may particularly provide low losses, e.g. below 4 dB/cm. The Ge layer may have a thickness between 1 and 6 micrometers, e.g. about 2 or 4 micrometers, in some of these examples. In some examples, the optical waveguide C may comprise SiGe. Such a waveguide may particularly provide low losses, e.g. below 5 dB/cm. The SiGe layer may have a thickness between 1 and 6 micrometers, e.g. about 2 or 4 micrometers, in some of these examples.

In other examples, the optical waveguide may comprise a top SiGe layer on top of a middle graded SiGe layer (in composition) on top of a bottom Si layer. For instance, a Si_{0.2}Ge_{0.8} layer may be provided on top of a Si₁₋ₓGeₓ layer, and the Si₁₋ₓGeₓ layer may be provided on top of a Si layer. Index “x” may vary from 0.8 on the top surface of the graded SiGe layer to 0 on the bottom surface of the graded SiGe layer. The Si_{0.2}Ge_{0.8} layer may have a thickness of about 2 micrometers, and the graded SiGe layer may have a thickness of about 11 micrometers. Other examples in which the percentages of Si and Ge in the top layer (and therefore the compositional grading of the middle layer) are different may be possible. Other examples in which the thicknesses of Si and Ge are different may also be possible.

In the example of FIGS. 2 and 4, the optical waveguide C is embedded within the top portion of the substrate Cd such that the top surface of the waveguide is flush with a top surface of the top portion of the substrate Cd. In other examples, the top surface of the waveguide does not need to be flush with the top surface of the top portion of the substrate Cd, e.g. the top surface of the waveguide C may be positioned above or below the top surface of the top portion of the substrate Cd. In some examples, the bottom surface of the optical waveguide may touch the top surface of the bottom portion of the substrate S. Although the waveguide C is illustrated as having a rectangular shape in cross-section in FIGS. 2-5, other shapes may also be possible. In some examples, the waveguide C may have a triangular, an oval or circular shape or any other suitable shape in cross-section.

The electro-optic modulator of FIGS. 2-5 further comprises a first (bottom in these examples) graphene layer Gb arranged such that input light L is absorbed by the electro-optic modulator during operation. In the examples of the figures, the graphene layer Gb extends over at least a portion of the optical waveguide C, in particular over the entire optical waveguide. The graphene layer Gb may e.g. be provided on top of the waveguide and a portion of the top portion of the substrate Cd. Causing the graphene layer Gb to extend beyond the optical waveguide C, i.e. over at least a portion of the cladding layer Cd, may improve the performance of the electro-optic modulator. In some examples, the graphene layer(s) may extend beyond the optical waveguide by up to about 25% of the width of the waveguide. Extending further beyond 25% of the width of the waveguide does not significantly further improve the performance.

In other examples, the graphene layer Gb may e.g. be provided directly on top of the waveguide C, i.e. the dielectric layer D1 and a portion of the cladding Cd above the optical waveguide C may be absent. In other examples, the graphene layer Gb may be provided in other suitable positions, e.g. below the optical waveguide C.

The electro-optic modulator of the examples of FIGS. 2-5 further comprises a dielectric layer D2 on top of the graphene layer Gb. The dielectric layer D2 may for example comprise one or more of the following materials: HfO₂, SiO₂, Si₃N₄, Al₂O₃, ZrO₂, TiO₂, TiN, HfSiO₄, ZrSiO₄, calcium copper titanate, barium titanate, strontium titanate, barium strontium titanate, polystyrene, polypropylene, polyamide, polyethylene, polytetrafluoroethylene and transition-metal dichalcogenide (TMD or TMDC). The dielectric layer D2 may comprise one or more two-dimensional (2D) materials. The dielectric layer D2 may comprise any suitable 2D (electric) insulator. The dielectric layer D2 may comprise a combination of a suitable 2D (electric) insulator and 3D oxide materials.

The electro-optic modulator of FIGS. 2-5 further comprises a second (top in these examples) graphene layer Gu, specifically above the (first) graphene layer Gb, such that input light L is absorbed by the electro-optic modulator during operation. In this example in particular, the second graphene layer Gu may absorb less light than the first graphene layer Gb. Also like the first graphene layer, the second graphene layer may extend over at least a portion of the optical waveguide C, for example over a portion of the optical waveguide only, over the entire optical waveguide (without extending beyond it), or over the entire optical waveguide and over at least a portion of the cladding layer Cd. Providing the graphene layer Gu to extend beyond the optical waveguide C, i.e. over at least a portion of the cladding layer Cd, may improve the performance of the electro-optic modulator.

The second graphene layer Gu may be referred to as top graphene layer, whereas the (first) graphene layer Gb may be referred to as bottom graphene layer. The graphene layer Gu may e.g. be provided on top of the dielectric layer D2 and Cd. In other examples, the first Gb and second Gu graphene layers may be provided in other suitable positions, e.g. below the optical waveguide C. A dielectric layer D2 may be provided between the first graphene layer Gb and the second graphene layer Gu.

One or more additional dielectric layers between the top and bottom graphene layers may be provided. In examples, the graphene layers, e.g. the top and/or bottom graphene layers, may be arranged (“sandwiched”) between dielectric layers. Sandwiching the top and/or bottom graphene layers with a dielectric may increase the quality of the top and/or bottom graphene layers.

In the example of FIGS. 2-5, the electro-optic modulator comprises a dielectric layer D1 on top of the top portion of the substrate Cd and the optical waveguide C, and below the bottom graphene layer Gb. A bottom surface of the dielectric layer D1 touches a top surface of the top portion of the substrate Cd and the optical waveguide C, and a top surface of the dielectric layer D1 touches a bottom surface of the (bottom) graphene layer Gb, in this example. In this example, the electro-optic modulator also comprises a dielectric layer D3 on top of the second graphene layer Gu. A bottom surface of the dielectric layer D3 touches a top surface of the (top) graphene layer Gb in this example. The dielectric layer D1 may be a 3D dielectric layer or a 2D material and may comprise oxides or nitrates. The base dielectric layer D1 may for example comprise SiO₂. The base dielectric layer D1 may comprise, e.g. be made of, at least one of the following 2D layered materials: hBN, MoTez, WSez, WS₂, MoS₂, MoSez, WS, WSez, black phosphorus, or SnSz. This layer D1 may be omitted in other examples. The dielectric layer D3 may be a 3D dielectric layer or a 2D material and may comprise oxides or nitrates. This layer D3 may be omitted in other examples.

Optionally, one or more additional dielectric layers may be placed on top and/or underneath the top and/or bottom graphene layers.

All the layers herein are in contact, i.e. touch an adjacent layer. For example, a top surface of the dielectric layer D2 touches a bottom surface of the graphene layer Gu, and a bottom surface of the dielectric layer D2 touches a top surface of the graphene layer Gb. And a bottom surface of the dielectric layer D3 touches a top surface of the second graphene layer Gu.

If present, in some examples one or more of the dielectric layers D1, D2, D3 may comprise one or more of the following 2D layered materials: hBN, MoTe₂, WSe₂, WS₂, graphene, MOS₂, MoSe₂, WS₂, WSe₂, black phosphorus and SnS₂. Throughout the present disclosure, the terms 2D material or 2D layered material may be used to refer to nanomaterials defined by their property of being merely one or two or a few atoms thick. They are herein referred to as 2D (layered) materials because they are substantially two-dimensional.

The thickness of the dielectric layer D2 may be between 5 nm and 2000 nm, e.g. between 5 and 500 nm, e.g. between 9 nm and 30 nm in some examples.

In some examples, one or more of the dielectric layers D1, D2, D3 may be omitted. For example, dielectric layers D1 and D3 may be omitted.

The electro-optic modulator may comprise two electrodes M1, M2. A drive voltage is to be applied between the electrodes M1, M2 to operate the electro-optic modulator. The terms “drive voltage” and “applied voltage” are used interchangeably herein. The two electrodes may be arranged on top, optionally partially on top, of the top portion of the substrate Cd. The electrodes may also be on top of the dielectric layers D1, D2 or D3 in some examples. The optical waveguide C and the abovementioned layers D1, Gb, D2, Gu, D3 may be (laterally) provided between the electrodes M1, M2, e.g. as shown in FIGS. 2-5. In some examples, a longitudinal direction of the waveguide C and of the first electrode M1 and of the second electrode M2 may be substantially parallel. The first M1 and second M2 electrodes may be separated along a direction which is perpendicular to the length of the waveguide. This direction may be referred to as lateral direction.

The first graphene layer Gb may extend from the first electrode M1 laterally towards the second electrode M2, and the second graphene layer Gu may extend laterally from the second electrode M2 opposite the first electrode M1 towards the first electrode M1. The first graphene layer Gb may be arranged over the waveguide and not reach the second electrode M2, and the second graphene layer Gu may be arranged over the optical waveguide and not reach the first electrode M1.

As indicated previously, FIGS. 3 and 5 schematically illustrate a cross-section of the electro-optic devices of FIGS. 2 and 4, respectively, but they additionally include a portion of the substrate layer Cd on top of the waveguide C. In FIG. 3, the Gu and Gb layers also extend beyond the optical waveguide C along a width direction of the waveguide (and the modulator).

In the example of FIGS. 2, 3, 4 and 5, the dielectric layer D2 extends (along the lateral direction) between, and touches, the first electrode M1 and the second electrode M2. The first graphene layer Gb and the dielectric layer D1 touch the first electrode M1 and extend (along the lateral direction) over the top portion of the substrate Cd and the optical waveguide C in cross-section, but without reaching the second electrode M2. One end of the first graphene layer Gb is configured to be electrically connected to the first electrode M1. Other extensions of the layers in cross-section may be possible.

The second graphene layer Gu and the dielectric layer D3 touch the second electrode M2 and extend (along the lateral direction) from it over the top portion of the substrate Cd and the optical waveguide C in cross-section, but without reaching the first electrode M1. One end of the second graphene layer Gu is configured to be electrically connected to the second electrode M2. Other extensions of the layers in cross-section may be possible.

In some examples, an electro-optical modulator as described herein may implement an interferometer arrangement, for example a Mach-Zehnder interferometer-based arrangement. The interferometer may comprise two or more optical waveguide branches, separated from but connected with each other. At least one of the branches may comprise an electro-optical modulator as described herein.

In some examples, the electro-optic modulator, i.e. the Mach-Zehnder interferometer, may comprise a first optical waveguide branch or arm and a second optical waveguide branch or arm. The first optical waveguide branch may comprise the optical electro-optic modulator as described above, and the second optical waveguide branch may or may not comprise an additional electro-optic modulator. The first and second optical waveguides branches may be separated in a direction which is perpendicular to a longitudinal direction of the first and second optical waveguide branches (the longitudinal direction of the waveguide being the direction of transmission of light). In some examples, the interferometer-based arrangement may have more than two branches.

In some examples, the additional waveguide(s) of the additional electro-optic modulator(s) may be configured to operate at wavelengths between 8 micrometers and 15 micrometers. I.e., in some examples all optical waveguides may be configured to operate at wavelengths between 8 micrometers and 15 micrometers, whereas in other examples, only one or not all of the optical waveguides may be configured to operate at wavelengths between 8 micrometers and 15 micrometers.

A third electrode may be provided in some examples, and the second optical waveguide branch may be between the second electrode and the third electrode. The Mach-Zehnder interferometer may have several configurations, e.g. as explained with respect to FIGS. 10A-10E of document US 2021/0173281 A1.

The arms of the Mach-Zehnder interferometer may be driven in a push-pull manner in some examples.

FIG. 6 illustrates an example of the evolution of the normalized absorption of a graphene electro-optic modulator such as the ones of FIGS. 2-5 as a function of the wavelength of the input light and the drive voltage. The graph of FIG. 6 is common to all the electro-optic modulators based on graphene which comprise one or two layers of graphene separated by one or more dielectric layers and arranged with, e.g. on top of or below, a waveguide, e.g. the electro-optic modulators of FIGS. 2-5. It should be noted that if the graphene layer(s) and the dielectric layer(s) are arranged below the optical waveguide, they are also arranged above the bottom portion of the substrate S.

Four vertical lines are indicated in FIG. 6. From left to right, the following applies: the left vertical line, at 1.55 micrometers, represents a usual wavelength of operation of a graphene based electro-optic modulator. The next vertical line, at 3 micrometers, represents the bottom boundary of the MWIR wavelength range. The following vertical line, at 8 micrometers, represents the bottom boundary of the LWIR wavelength range. And the right vertical line of this figure, at 15 micrometers, represents the top boundary of the LWIR wavelength range. As can be seen in this FIG. 6, the absorption of the graphene based electro-optic modulator is dependent on the drive voltage and on the operation wavelength.

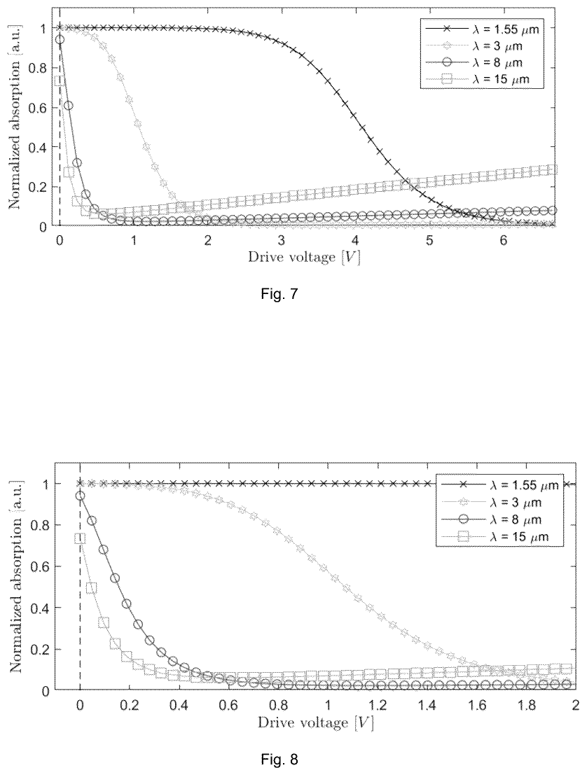

FIG. 7 schematically illustrates the evolution of the normalized absorption of the graphene based electro-optic modulator as a function of the drive voltage for the four operation wavelengths indicated in FIG. 6: 1.55 micrometers, 3 micrometers, 8 micrometers and 15 micrometers. FIG. 8 schematically illustrates the region up to a drive voltage of 2 V of FIG. 7. FIGS. 7 and 8 show that the offset voltage is about 3 volts at an operation wavelength of 1.55 micrometers, about 0.5 volts at an operation wavelength of 3 micrometers, of 0 volts at an operation wavelength of 8 micrometers and of 0 volts at an operation wavelength of 15 micrometers. Therefore, operating at a wavelength of 8 micrometers or more can reduce the offset voltage of the graphene based electro-optic modulator to below 0.1 V, and even to about 0 V. The modulator may be quickly or immediately set in the operation window. And therefore one or more of lower power consumption, lower heat generation, higher reliability, reduced errors due to non-linearities and reduced cost, reduced complexity of the driving circuit and no need of amplifiers, e.g. current, voltage or transconductance amplifiers, may be achieved. Low timing jitter and high-speed performance may be enabled.

In addition, the slope of the curves of operation at a wavelength of 8 and 15 micrometers are steeper than the slopes of the curves of operation at a wavelength of 1.55 and 3 micrometers. Therefore, the static modulation efficiency, and therefore the dynamic modulation efficiency of the electro-optic modulator, have also been increased by operating at a wavelength of between 8 and 15 micrometers.

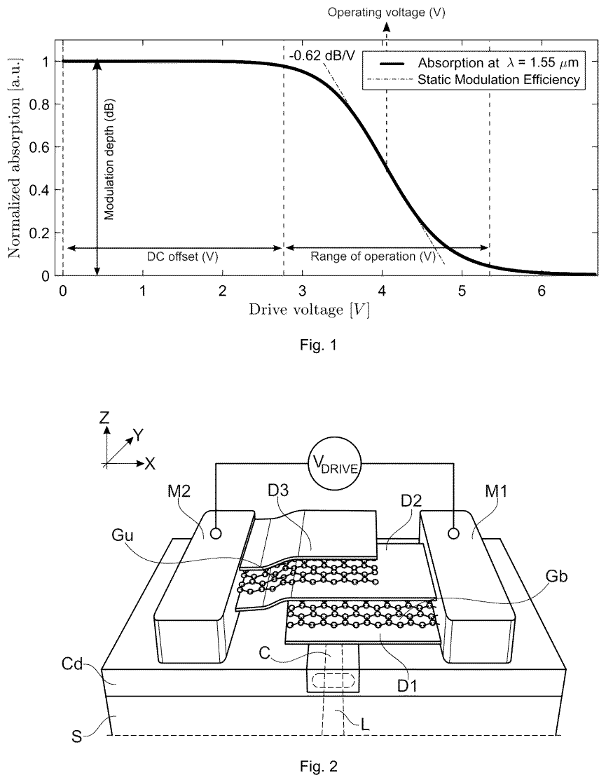

A static modulation efficiency is generally defined as the ratio of the change in the optical output power, which is usually expressed in dB, to the change in the drive voltage, usually expressed in volts. Static modulation efficiency therefore usually has units of dB/V and can be determined as the slope of the optical output power as a function of the drive voltage curve. An example of such a slope is illustrated in FIG. 1, and as it can be seen therein, the static modulation efficiency is of −0.62 dB/V in this example (i.e. for 1.55 micrometers).

The concept of dynamic modulation efficiency is similar to the concept of static modulation efficiency, but instead of being measured in DC, it is measured by applying an AC voltage. To determine the dynamic modulation efficiency the AC voltage is usually applied in the GHz regime. The dynamic modulation efficiency is calculated as the extinction ratio (ER), extracted from an eye diagram, divided from the applied AC voltage applied (Vpp).

Dynamic and static modulation efficiency are related. If the static modulation efficiency is improved, a higher dynamic modulation efficiency is generally also expected. The bandwidth may however be a limiting factor which causes the dynamic modulation efficiency to degrade with respect to the static modulation efficiency.

As shown in FIGS. 7 and 8, the modulation depth for the 15 micrometers trace has decreased compared to the 8 micrometers one. The modulation depth of an electro-optic modulator may be understood as the difference between a maximum power and a minimum power absorbed by the electro-optic modulator. It is usually measured in dB. An example of modulation depth is illustrated in the graph of FIG. 1.

Accordingly, a very low or even zero offset voltage together with increased static and dynamic modulation efficiencies and without decreased speed and modulation depth may be obtained by operating at a wavelength of 8 micrometers. And increased static and dynamic modulation efficiencies may be achieved in general in the LWIR range.

The offset voltage tends to depend on the temperature and may slightly depend on graphene quality, but as shown below with respect to FIG. 16, a zero offset voltage is maintained when operating in the LWIR range even if temperature varies, for example from 150 K to 300 K.

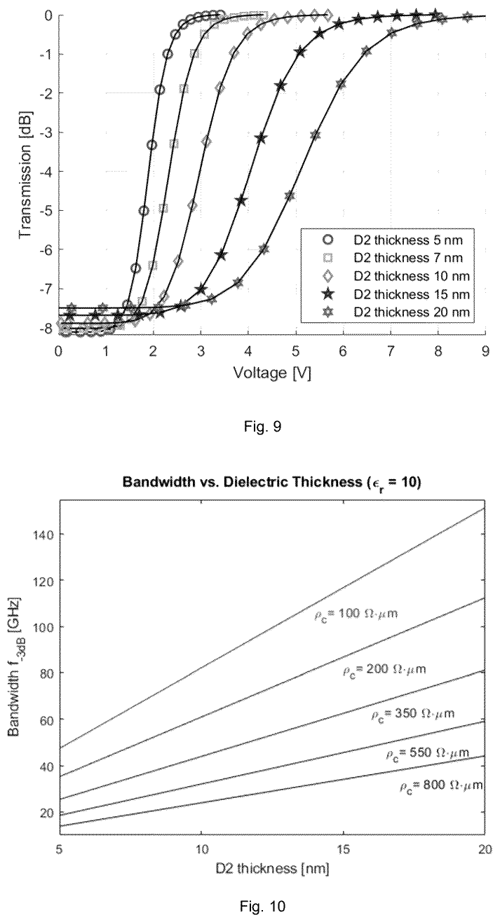

It is noted that if the electro-optical modulator was not configured to operate at wavelengths between 8 micrometers and 15 micrometers, but e.g. at 1.55 micrometers instead, the offset voltage may be reduced in other manners. For example, the thickness of the amount of dielectric material between the first graphene layer Gb and the second graphene layer Gu, e.g. the thickness of the dielectric layer D2 may be reduced for reducing the offset voltage. However, as explained below, leakage and dielectric breakdown may arise. Also, as can be seen in FIG. 9 explained below, bandwidth and modulation speed may be reduced.

FIG. 9 shows a graph with curves of transmission, in dB, as a function of applied voltage, in V, for different thicknesses of the dielectric layer D2 of the electro-optic modulator of FIG. 2, operating at a wavelength of 1.55 micrometers. FIG. 10 shows a graph of bandwidth, in GHz, as a function of dielectric thickness of the dielectric layer D2 of the electro-optic modulator of FIG. 2. The lines are shown for graphene-to-metal contact resistivity of 100, 200, 350, 550 and 800 Ω·μm.

The simulations have been performed for an electro-optic modulator having a length of 60 μm (in the Y-direction, refer to FIG. 22). The bottom portion of the substrate S is silicon and the top portion of the substrate Cd is SiO₂. The dielectric layers D1 and D3 have a thickness of 10 nm each. The thickness of the dielectric layer D2 has been varied, the permittivity of the dielectric layer D2 is kept at 10, and transmission curves for a 5, 7, 10, 15 and 20 nm thickness of the dielectric layer D2 are shown in FIG. 9.

In the simulations, the waveguide C is a silicon waveguide and has a height of 220 nm and a width of 450 nm. The electrodes M1 and M2 have a thickness of 80 nm (in a vertical direction of FIG. 2) and are separated by a distance of 2000 nm. The thickness of a SiO₂ portion of the cladding layer Cd between the waveguide C and the bottom of the dielectric layer D1 (not shown in FIG. 2 but shown in FIG. 3) is of 10 nm. The permittivity Er is 10 for these simulations. The temperature has been set to 300 K.

As can be seen in FIG. 9, reducing the thickness of the dielectric layer D2, and in general of the amount of dielectric material between the first Gb and second Gu graphene layers, reduces the offset voltage. The DC offset voltage is of at least 1.5 V. However, a thickness of 5 nm is already at the limit. I.e., the risk of dielectric breakdown may be excessive for a dielectric thickness of 5 nm. However, as explained below, reducing the D2 dielectric thickness may produce leakage and dielectric breakdown and, more importantly, reduce the bandwidth and the modulation speed, as can be seen in the FIG. 10. As can be observed in FIG. 10, reducing the thickness of D2 may considerably reduce the bandwidth of the electro-optic modulator, for all the graphene-to-metal contact resistivities considered.

As can be seen, the parameters of an electro-optic modulator are related to one another, and the effect of modifying one parameter is not obvious in the other parameters. As shown in FIGS. 9 and 10, reducing dielectric thickness reduces offset voltage, but at a cost of also reducing modulation speed and bandwidth. In addition, the risk of dielectric leakage and dielectric breakdown also increases.

Another way to reduce offset voltage may be by increasing the permittivity of the dielectric layer(s) between the first Gb and second Gu graphene layers. Simulations have been performed for the electro-optic modulator of FIG. 2 operating at a wavelength of 1.55 micrometers, with the data indicated above. This time, the thickness of the dielectric layer D2 is kept at 10 nm, but the permittivity is varied and takes values of 7, 10, 13, 16, 19 and 30.

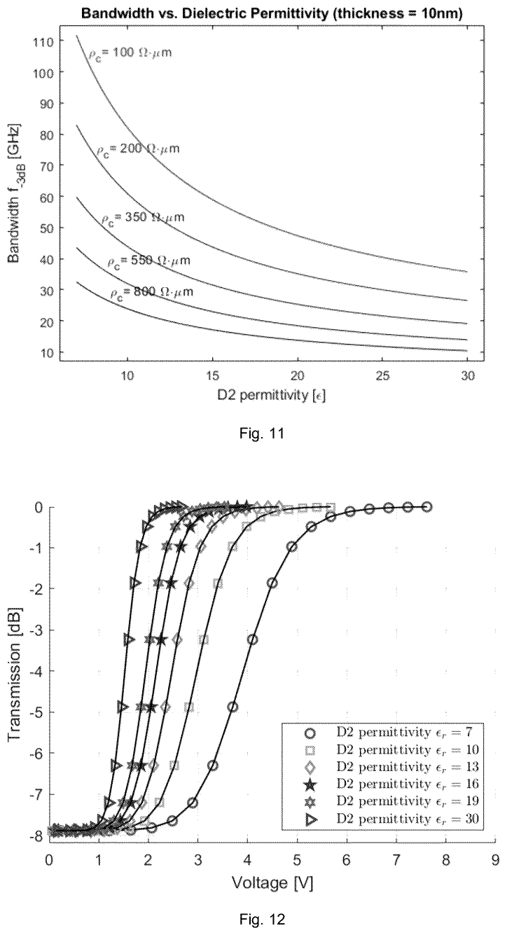

FIG. 11 shows a graph with curves of bandwidth, in GHz, as a function of permittivity of the dielectric layer D2 of the electro-optic modulator of FIG. 2 operating with a 1.55 micrometers light. The curves are shown for different graphene-to-metal contact resistivities, namely for a graphene-to-metal contact resistivity of 100, 200, 350, 550 and 800 Ω·μm.

FIG. 12 shows a graph with curves of transmission, in dB, as a function of applied voltage, in V, for different permittivities of the dielectric layer D2 of the electro-optic modulator of FIG. 2.

As can be seen in FIG. 12, increasing the permittivity of the dielectric layer D2, and in general increasing the permittivity of the amount of dielectric material between the first Gb and second Gu graphene layers, reduces the offset voltage. The DC offset voltage is of at least 1 V. However, increasing the dielectric permittivity may reduce the bandwidth and the modulation speed, as can be seen in the FIG. 11.

FIGS. 11 and 12 show that increasing the permittivity Er reduces offset voltage. But a DC offset voltage remains above 1 V for a high permittivity (εᵣ=30), see FIG. 12. And again, as can be seen in these figures, modulation speed and bandwidth decrease when increasing permittivity.

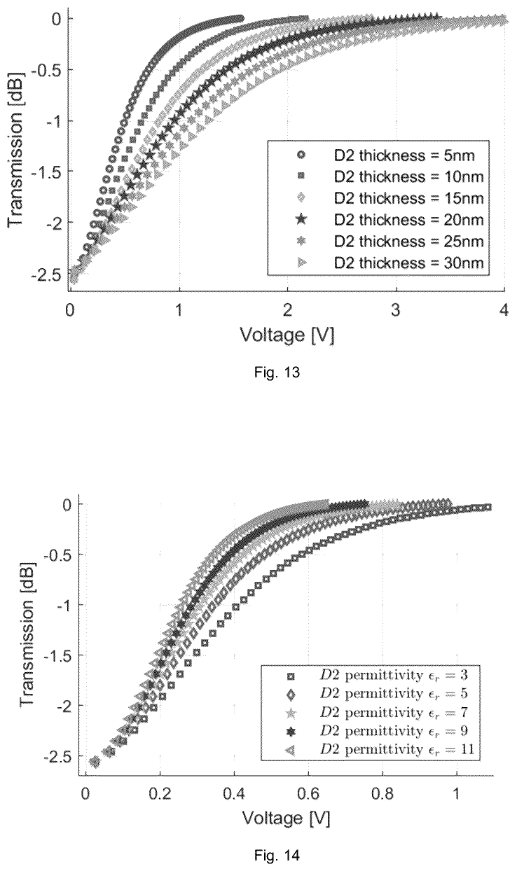

FIG. 13 shows a graph with curves of transmission, in dB, as a function of applied voltage, in V, for different thicknesses of the dielectric layer D2 of the electro-optic modulator of FIG. 4 operating with a 8 micrometers light. The offset voltage for all the curves is zero. This figure shows that, irrespectively of the D2 dielectric thickness, the DC offset voltage is always zero, thus not compromising the bandwidth and speed of the electro-optic modulator.

FIG. 14 shows a graph with curves of transmission, in dB, as a function of applied voltage, in V, for different permittivities of the dielectric layer D2 of the electro-optic modulator of FIG. 4 operating with a 8 micrometers light. The DC offset voltage for all the curves is zero. This figure shows that, irrespectively of the D2 dielectric permittivity, the DC offset voltage is always zero, thus not compromising the bandwidth and speed of the electro-optic modulator.

The electro-optic modulator, e.g. the dimensions of its components, has been adapted to operate in the LWIR range. The simulations of FIGS. 13 and 14 have been performed for an electro-optic modulator having a length of 250 μm (in the Y-direction, refer to FIG. 4). The bottom portion of the substrate layer S is silicon and the top portion of the substrate layer Cd is SiO₂. The dielectric layer D1 has a thickness of 2 nm and the dielectric layer D3 has a thickness of 1000 nm. The thickness of the dielectric layer D2 has been varied and transmission curves for a 5, 7, 10, 15, 20, 25 and 30 nm thickness of the dielectric layer D2 are shown in FIG. 13. The permittivity of the dielectric layer D2 is 3.6. The permittivity is varied and takes values of 3, 5, 7, 9 and 11 in FIG. 14. In this figure, the dielectric layer D2 has a thickness of 10 nm.

In the simulations of FIGS. 13 and 14, the waveguide C is a Ge waveguide and has a height of 1550 nm and a width of 4650 nm. The electrodes M1 and M2 have a thickness of 80 nm (in a vertical direction of FIG. 4) and are separated by a distance of 2000 nm. The thickness of a SiO₂ cladding layer (not shown in FIG. 4 but shown in FIG. 5) is 2 nm. The temperature has been set to 300 K.

In view of at least FIGS. 13 and 14, providing an electro-optic modulator configured to operate at wavelengths between 8 micrometers and 15 micrometers is an effective manner of reducing the offset voltage while avoiding the above disadvantages (reduction of bandwidth and of modulation speed), and even increasing the static and dynamic modulation efficiencies.

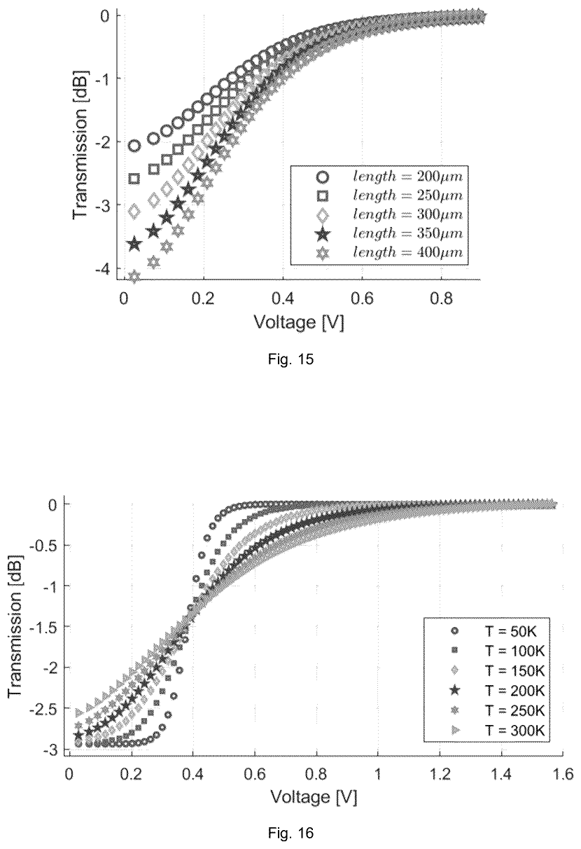

FIG. 15 shows a graph with curves of transmission, in dB, as a function of applied voltage in V, for different lengths of the electro-optic modulator of FIG. 4 operating with a 8 micrometers light. Unless indicated to the contrary, the previous parameters indicated for FIGS. 13 and 14 apply to this figure. In this figure, the thickness of the dielectric layer D2 is 20 nm, the permittivity of the dielectric layer D2 is 9, and the length has been varied between 200 micrometers and 400 micrometers. FIG. 15 shows that the length of the electro-optic modulator changes the amplitude of the modulation, but that the DC offset voltage for all the curves is zero.

FIG. 16 shows a graph with curves of transmission, in dB, as a function of applied voltage, in V, for the electro-optic modulator of FIG. 4 operating with 8 micrometers light at different temperatures of operation. Unless indicated to the contrary, the previous parameters indicated for FIGS. 13 and 14 apply to this figure. In this figure, the thickness of the dielectric layer D2 is 10 nm, the permittivity of the dielectric layer D2 is 3.6, and the temperature was varied between 50 K and 300 K. The DC offset voltage for all the curves is zero.

Therefore, FIGS. 15 and 16 show that, even when varying the length of the electro-optic modulator and/or the temperature of operation, the result of having a very low or zero offset voltage of FIGS. 7 and 8 still holds.

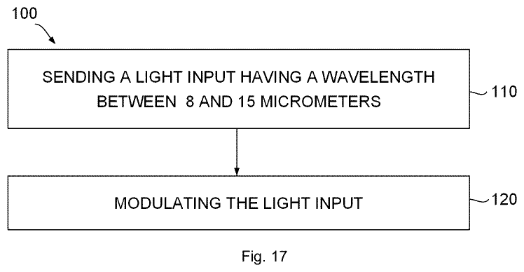

According to a further aspect of the disclosure, a method 100 of operating an electro-optic modulator as described herein, in particular for reducing offset voltage, is provided. The method is illustrated in the flow chart of FIG. 17. The method comprises, at block 110, sending a light input having a wavelength between 8 micrometers and 15 micrometers to the optical waveguide. For example, a laser beam may be sent towards the waveguide C. The method comprises, at block 120, modulating the light input.

As the waveguide C of the electro-optic modulator based on graphene is configured to operate in a wavelength range between 8 micrometers and 15 micrometers, the input light may be modulated with a very low, or even without an, offset voltage. The modulator may therefore be operated with low power consumption and in a reliable manner. Static and dynamic efficiencies may be increased without compromising the speed of the modulator and without the need of current, voltage or transimpedance amplifiers.

In some examples, the offset voltage, i.e. the DC component of the driving voltage, may be lower than 1 V, in particular lower than 0.5 V and more in particular lower than 0.2 V. In some of these examples, an offset voltage may be lower than 0.1 V, e.g. about or of 0 V.

The method may further comprise applying a drive voltage lower than 1 V, in particular lower than 0.5 V, and more in particular lower than 0.2 V. In some of these examples, a drive voltage lower than 0.1 V may be applied.

Different types of modulations may be performed with the electro-optic modulator. For example, modulating may comprise modifying an amplitude, a phase or a polarization of the light input.

This written description uses examples to disclose a teaching, including the preferred embodiments, and also to enable any person skilled in the art to put the teaching into practice, including making and using any devices or systems and performing any incorporated methods. The patentable scope is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims. Aspects from the various embodiments described, as well as other known equivalents for each such aspects, can be mixed and matched by one of ordinary skill in the art to construct additional embodiments and techniques in accordance with principles of this application. If reference signs related to drawings are placed in parentheses in a claim, they are solely for attempting to increase the intelligibility of the claim, and shall not be construed as limiting the scope of the claim.

1. An electro-optic modulator comprising:
a substrate;
an optical waveguide arranged with the substrate; and
a first graphene layer and a second graphene layer arranged such that input light is absorbed by the electro-optic modulator during operation, the first and second graphene layers overlapping each other and separated from each other by one or more dielectric layers;
wherein the electro-optic modulator is configured to operate at wavelengths between 8 micrometers and 15 micrometers.

2. The modulator of claim 1, wherein the optical waveguide comprises a group IV semiconductor, a hollow waveguide or a polymer-based waveguide.

3. The modulator of claim 1, wherein the optical waveguide comprises Ge.

4. The modulator of claim 1, wherein the optical waveguide comprises SiGe.

5. The modulator of claim 1, wherein the first and the second graphene layers overlap with each other for at least a portion of a width of the optical waveguide.

6. The modulator of claim 5, wherein the first and the second graphene layers overlap with each other for the entire width of the optical waveguide.

7. The modulator of claim 5, wherein the first and the second graphene layers overlap with each other, and wherein
at least one of the first and the second graphene layers extends along the entire width of the optical waveguide and beyond by up to 25% of the width of the optical waveguide.

8. The modulator of claim 1, wherein the first graphene layer extends from a first electrode and wherein the second graphene layer extends from a second electrode opposite to the first electrode.

9. The modulator of claim 8, wherein the first graphene layer reaches the second electrode and wherein the second graphene layer reaches the first electrode.

10. The modulator of claim 1 further comprising a cladding, wherein at least a portion of the optical waveguide is embedded within the cladding.

11. The modulator of claim 10, wherein a top surface of the waveguide is flush with a top surface of the cladding.

12. The modulator of claim 1, wherein the modulator is an interferometer, in particular a Mach-Zehnder interferometer, and comprises:
two or more optical waveguide branches, separated from but connected with each other; at least one of the branches comprising the electro-optical modulator of claim 1.

13. A method of operating an electro-optic modulator including a substrate, an optical waveguide arranged with the substrate, a first graphene layer and a second graphene layer arranged such that input light is absorbed by the electro-optic modulator during operation, the first and second graphene layers overlapping each other and separated from each other by one or more dielectric layers, the method comprising:
sending a light input having a wavelength between 8 micrometers and 15 micrometers to the optical waveguide; and
modulating the light input.

14. The method of claim 13, further comprising applying a drive voltage lower than 1 V.

15. The method of claim 14, wherein an applied drive voltage is lower than 0.5.

16. The method of claim 13, wherein an offset voltage is lower than 0.5 V.

17. The method of claim 13, wherein modulating comprises modifying an amplitude, a phase or a polarization of the light input.

18. The method of claim 15, wherein the applied drive voltage is lower than 0.2 V.

19. The method of claim 13, wherein an offset volage is lower than 0.2 V.

20. The method of claim 19, wherein an offset voltage is lower than 0.1 V and an applied drive voltage is lower than 0.2 V.
